(19) United States
(12) Patent Application Publication
(10) Pub. No.: US 2019/0303670 A1
(43) Pub. Date: Oct. 3, 2019

(54) Inspection Of Freight Containers And Other Transport Industry Equipment

(71) Applicant: PEIR, Inc., Henderson, NV (US)

(72) Inventor: Aaron Bryden, Minneapolis, MN (US)

(21) Appl. No.: 16/273,971

(22) Filed: Feb. 12, 2019

Related U.S. Application Data
(60) Provisional application No. 62/629,460, filed on Feb. 12, 2018.

(51) Int. Cl. G06K 9/00; H04L 9/32; H04L 9/06; G06N 3/04

(52) U.S. Cl. CPC G06K 9/00671; H04L 9/3247; H04L 2209/38; G06N 3/0418; H04L 9/0643

(57) ABSTRACT

The disclosed devices, systems, and methods relate to an AR inspection system which can be used to capture data relating to an inspected object. The system can have various steps including guiding or otherwise directing a user in taking a series of photos or videos as captured data, the captured data then being hashed to create a cryptographic signature, and the cryptographic signature being stored in a repository such as a blockchain for subsequent access and validation. The cryptographic signature can be later compared with the corresponding photo or video for purposes of authentication.

### CROSS-REFERENCE TO RELATED APPLICATION(S)

This application claims priority to U.S. Provisional Application No. 62/629,460 filed Feb. 12, 2018 and entitled “Inspection Of Freight Containers And Other Transport Industry Equipment,” which is hereby incorporated by reference in its entirety under 35 U.S.C. § 119(e).

### TECHNICAL FIELD

The disclosed technology relates generally to devices, systems and methods for inspection and/or storage, and in particular, to the devices, methods, and design principles allowing for the imaging and inspection of objects and the capture and storage of resulting data.

### BACKGROUND

Much of the transport industry relies on the exchange of closed shipping containers in which the containers but not the freight within the containers are handled at points of material transfer, significantly reducing the cost of transport. However, at points of exchange, damage to the transport equipment must be documented and the costs of repair assigned. For example, containerized intermodal freight transport is one system in which freight is shipped in an intermodal container or vehicle without direct handling of the freight itself. The containers are known as intermodal containers (or ISO containers because the dimensions and other specifications are defined by ISO standards). Each container is identified by a visual marking system (code) determined by ISO 6346, which establishes a unique serial number for every container identifying the owner, country, size, type, and equipment category. As these containers are used they may become damaged, and the costs for repair of the damage are the responsibility of the organization/individual (e.g., trucker) in current possession of the transport container. Because of this, containers are inspected at each point of transfer and the results of these inspections are kept.

A fundamental aspect of this type of freight transport is the transfer of the transport equipment between transport modes (e.g., trucking and/or rail companies). At each point of transfer a detailed inspection is performed to ensure that all equipment damage is documented and may be ascribed to the appropriate organization. This is a challenging and time-consuming process that is difficult to fully document. Current solutions include the manual use of software checklists in which the inspector visually inspects the container, checking off specific issues of concern (e.g., holes and cracks in the walls or roof, dents, and structural damage to the undercarriage), creating a photographic record of the damage, and uploading the results of the inspection to a server. Some large-scale facilities have high-cost drive-in inspection facilities that utilize computer visualization techniques to inspect containers and vehicles.

The manual inspection methods are problematic in that they rely on the inspector to view and find all the discrepancies and do not provide an independently verifiable record of the extent of the inspection (only the inspector's assertion of the completion of the inspection by signature). The drive-in and computer vision solutions, while providing complete and accurate records, are very expensive and as a result are not available to most intermodal and other transfer facilities nor are they irrefutable or tamper proof. As a result, it is difficult to document where in the chain of custody the equipment damage may have occurred and to identify the responsible party. The system described herein guides the inspection process, documents the results of the inspection, and provides an irrefutable record of the condition of the transport equipment at the time of transfer.

### BRIEF SUMMARY

Described herein are various embodiments that taken together form an inspection system that addresses these shortfalls. An inspection process would be performed using a smart phone or other mobile computing device capable of utilizing augmented reality tools and equipped with integrated cameras, inclinometers, and inertial motion unit (motion sensing) equipment. From this, the mobile computing device would determine the location of the inspector relative to the container, the type of container, and direct the inspection while recording either in photographs or video the inspection process. Areas of concern would be identified both by the inspector and via computer vision techniques and further documented via photo or video recording. By tracking the movement and location of the mobile computing device, the software would ensure that the inspection is complete or direct the inspector to areas still needing to be inspected. Following completion of the inspection, the completed inspection record would be validated and stored in a cryptographically secure file that may be maintained for business and legal use. After storage the cryptographic signature may be compared to the data in records, photos, and videos to ensure that the inspection records have not been altered since the time of the inspection. In alternate embodiments a public blockchain may be utilized for an additional layer of security.

In various Examples, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general Example includes a system for documenting the condition of containers, including: a networked device including a processor and at least one i/o component; and a networked repository, where the networked device is constructed and arranged to: capture inspection data into a packet, compute a cryptographic hash of the packet, and transmit the cryptographic hash to the networked repository for storage. Other embodiments of this Example include corresponding computer systems, apparatus, and computer programs recorded on one or more computer storage devices, each configured to perform the actions of the methods.

Implementations according to these Examples may include one or more of the following features. The system where the system is configured to integrate augmented reality (AR) into the system for guidance. The system where the system is configured to integrate visual tracking into the system for guidance. The system where visual tracking data is integrated into the inspection data packet. The system configured to integrate augmented reality (AR) into the system for guidance. The system where the networked device is constructed and arranged to integrate feature, object detection, plane detection and tracking data from the AR into the inspection data packet. The system where the system is constructed and arranged to validate packets via at least one of the feature, object detection, plane detection and tracking data.

The system where the system is configured to integrate data from a combination of fixed and mobile cameras into the system. The system where the system is configured to perform object detection methodology to automatically detect damage. The system where the object detection is performed via convolutional neural networks (CNN). Implementations of the described techniques may include hardware, a method or process, or computer software on a computer-accessible medium.

One general Example includes an inspection system, including: an inspection device including a processor and at least one camera; a repository including a blockchain, where the inspection device is constructed and arranged to: execute one or more inspection and/or guidance steps, capture inspection data, and transmit captured inspection data to the repository. Other embodiments of this Example include corresponding computer systems, apparatus, and computer programs recorded on one or more computer storage devices, each configured to perform the actions of the methods.

Implementations according to this Example may include one or more of the following features. The system where the processor is constructed and arranged such that additional automated processing of the inspection data triggers another action based on at least one of detected objects or detected object states of the imagery, other data collected or metadata. The system where the trigger includes damage detection using convolutional neural nets, optical character recognition and/or the extraction of sequences of characters or image characteristics that match either defined rules or a statistical inference of the probability that the image or associated text contains a shipping container code, drivers license number, VIN number, license plate or other alphanumeric identifier. Implementations of the described techniques may include hardware, a method or process, or computer software on a computer-accessible medium.

Another general Example includes an inspection and storage system, including: a networked device including a processor, a camera and an augmented reality interface; and a repository, where the networked device is executing an inspection platform constructed and arranged to: execute a series of guidance steps, capture a series of data relating to an inspected object, hash and store the captured data via an inspected packet in the repository, and validate queries to the hashed and stored data. Other embodiments of this Example include corresponding computer systems, apparatus, and computer programs recorded on one or more computer storage devices, each configured to perform

Implementations according to these Examples may include one or more of the following features. The system where the system is constructed and arranged to generate a cryptographic signature. The system where the system is constructed and arranged to validate captured data via the stored cryptographic signature. The system where duplicate cryptographic signatures are stored on the device and in the repository. The system where the guidance steps optionally include directed inspection of at least one portion of the object. The system where the processor is constructed and arranged to utilize computer vision. The system where the computer vision is configured to identify portions of damage to the object. The system where the guidance is updated in response to identified damage.

Implementations of the described techniques may include hardware, a method or process, or computer software on a computer-accessible medium. A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. One general aspect includes a system for documenting the condition of containers, including a mobile device including at least one I/O component, where the device is constructed and arranged to compile inspection data into a packet; and a component to compute a cryptographic hash of the packet for storage on a remote server.

Another aspect includes a system for analyzing the result of various methods for processing the inspection data, such as imagery or other data/metadata, and triggering or otherwise initiating further actions as appropriate. Other embodiments of this aspect include corresponding computer systems, apparatus, and computer programs recorded on one or more computer storage devices, each configured to perform the actions of the methods.

Implementations may include one or more of the following features. The system where the system is configured to integrate augmented reality (AR) into the system for guidance. The system where the system is configured to integrate visual tracking into the system for guidance. The system where the system is configured to integrate data from a combination of fixed and mobile cameras into the system. The system where the system is configured to perform object detection methodology, such as convolutional neural networks (CNN), into the system to automatically detect damage. Implementations of the described techniques may include hardware, a method or process, or computer software on a computer-accessible medium.

In one Example, a system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. One general aspect includes a system for documenting the condition of containers, including: a mobile device including at least one i/o component, where the device is constructed and arranged to compile inspection data into a packet; and compute a cryptographic hash of the packet for storage on a remote server. Other embodiments of this aspect include corresponding computer systems, apparatus, and computer programs recorded on one or more computer storage devices, each configured to perform the actions of the methods.

Additionally, the container lock may be sealed with a smart lock and/or a damage sensor with Bluetooth, NFC, or other communication protocol that will indicate when the lock was put in place, if it has been opened, and any other conditions of interest (e.g., weather, severe shock). This will provide a secure chain of custody and load treatment. Including this information in the secure file will ensure that a complete record of the container and freight has been maintained.

Described herein are various embodiments relating to systems and methods for improving the reliability and veracity of container inspections. Although multiple embodiments, including various devices, systems, and methods of improving the thoroughness and completeness of the inspector's work flow and the reliability of consequent photos and videos are described herein as an “inspection system,” this discussion is in no way intended to be restrictive.

### BRIEF DESCRIPTION OF THE DRAWINGS

FIG. 1 shows an exemplary embodiment of the inspection system.

FIG. 2 is an overheard view of an exemplary embodiment of the inspection system.

FIG. 3 is a flowchart diagramming an exemplary embodiment of the inspection system.

### DETAILED DESCRIPTION

This disclosure relates to the various systems utilized to increase the reliability, improve the repeatability, and reduce the cost of the inspection, identification, and documentation of the condition of objects or spaces such as freight containers and other transport industry equipment (including but not limited to 18 wheel trailers; rental trailers, e.g., U Haul types of trailers; and moving containers, e.g., PODS, Packrat, and U-Pack types of shipping containers) by utilizing augmented reality and computer vision with a mobile computing device to perform a number of optional inspection and storage steps, as described herein.

Certain implementations of the disclosed validation system 10 have one or more components configured for performing one or more functions that represent a technical improvement by providing a platform capable of guiding the capture and storage of inspection data. In various implementations, the system may perform one or more functions, such as guiding the inspection work flow; documenting completion of the inspection utilizing computer vision, onboard integrated camera(s), inclinometers, and other available inertial measurement units (“IMUs”); linking the inspection record with a container locking device or other status device that uses Bluetooth or other communication protocols to indicate the state of the container and container locks; and producing a highly tamper resistant record of the inspection including the physical completion of the inspection and a photographic/video record and the like. Further processes, steps and outcomes are of course possible, as will be appreciated by those of skill in the art. The disclosed embodiments therefore employ novel scanning and validation techniques for automating and directing the inspection and then utilizing a cryptographic hash to build and maintain a secure record of the inspection for business and legal purposes.

The disclosed implementations represent a technical improvement because it enables automated actions in response to detected inspection contents in a way in which the entire trail of evidence that led to the automated action can be proven from a public blockchain or other source of a verified cryptographic hash. The implementations also represent a technical improvement in that they allow for the capture of additional data including the tracking and other data generated by augmented reality platforms such as ARKit and ARCore in addition to the captured image data. These implementations including validation data provide a greater level of verification that no modifications to the captured data/image data have been made. This validation data can be utilized automatically or with analyst intervention to show that all collected data is plausibly consistent or, in the alternative, prove that it is not and that potential tampering has occurred. These implementations therefore represent a means of resistance to cyberattacks, hacking or other tampering, for example an attempt to insert false imagery into the inspection system. Accordingly, the disclosed implementations of the inspection system improve upon the current state of the art.

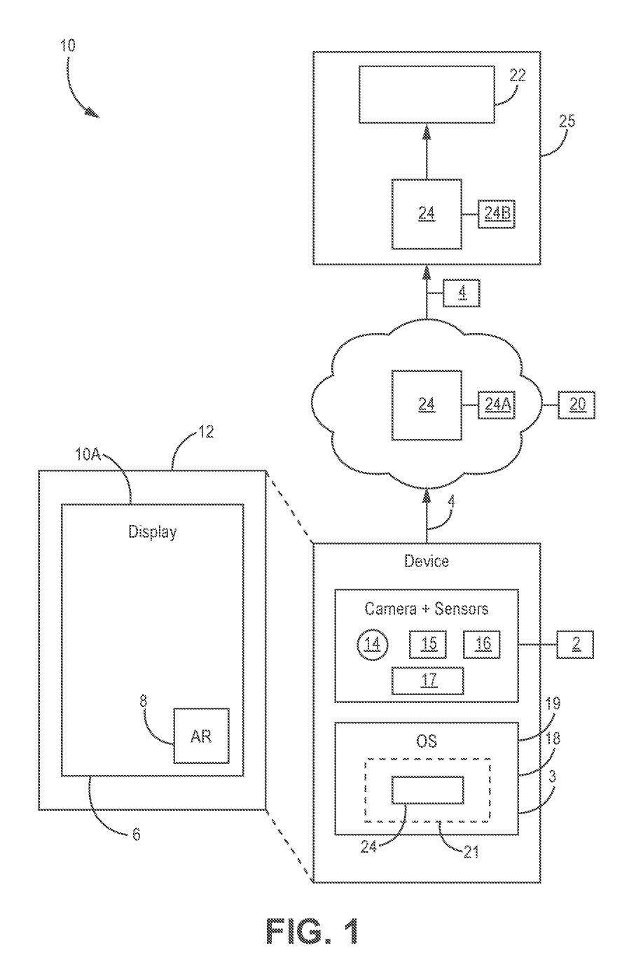

Turning to the drawings in greater detail, as shown in the implementations of FIGS. 1-3, the various embodiments disclosed or contemplated herein relate to a validation system 10 for guiding and documenting the process of recording the condition of an object 40. Certain implementations of the system 10 provide a platform 10A being executed on a device, as would be appreciated by those of skill in the art. Certain non-limiting examples of the object 40 being freight containers and other industrial equipment used for transport, such as chassis and trucks, including but is not limited to 18-wheel trailers; intermodal containers; rental trailers, e.g., U Haul types of trailers; moving containers, e.g., PODS, Packrat, and U-Pack types of shipping containers; and other industrial transportation equipment, such as chassis and trucks. The systems, methods and devices described herein according to certain implementations are also applicable to other physical objects 40, certain non-limiting examples including rental equipment and built environments such as rental units or apartments or other objects or environments that regularly undergo an inspection process and may benefit from encrypted inspection documentation, such as stored. Further examples would be apparent to those of skill in the art. While certain implementations may refer to a “container” specifically, it is explicitly understood that any of the aforementioned objects—and others that would be understood by those of skill in the art—are expressly contemplated.

It is further understood that the various embodiments of the validation system 10 and related methods and devices disclosed herein may be incorporated into or used with any other known validation systems, methods, and associated devices. For example, the various embodiments disclosed herein may be incorporated into or used with any of the systems, methods, and associated devices disclosed in co-pending U.S. application Ser. No. 15/331,531 (filed Oct. 21, 2016 and entitled “Apparatus, Systems and Methods for Ground Plane Extension”), 62/677,214 (filed May 29, 2018 and entitled “Industrial Augmented Reality System, Methods and Devices”), and Ser. No. 15/631,928 (filed on Jun. 23, 2017 and entitled “Cryptographic Signature System and Related Systems and Methods”), all of which are hereby incorporated herein by reference in their entireties.

Returning to the drawings in detail, and as shown in FIGS. 1-3, the validation system 10 may be used in the location 11 where an inspection takes place, and in exemplary implementation utilizes one or more devices 12 such as mobile computing devices 12 executing a software or firmware inspection platform 10A to capture data such as digital image data relating to the object 40 via inspection. It is understood that in various implementations, the inspection platform 10A may be installed software or non-downloadable software executing on the mobile device 12, such as via a browser or API. In various implementations, and as described herein, the inspection platform executes an augmented reality (“AR”) system 8 or platform to provide information and to the user during use. In some implementations the platform may utilize an inspection processing platform 10A that receives each inspection, processes the inspection to determine contents of the imagery such as objects or text and then other actions using methods such as webhooks/HTTP callbacks or other methods based on the contents of the imagery.

Certain non-limiting examples of the mobile computing device 12 include mobile phones using the Android or iOS operating systems and tablets—such as an iPad®—using similar operating systems. In various implementations, the device 12 has an application installed on it that is constructed and arranged to execute the various tasks required or operations of the system 10, including data capture and storage. In alternate implementations, a custom or purpose-built device 12 may be utilized.

In these implementations of the validation system 10, and as shown in FIG. 1, the device 12 or devices have various components 2, 3. In certain implementations, several input/output (“I/O”) components 2 and operating components 3 are provided. In further implementations, various input components 2 are integrated into the device 12, these components being configured to guide the inspection of equipment used for transport and document the current condition of the equipment. In certain embodiments, these I/O components 2 may include cameras 14 such as digital/video cameras 14, inclinometers 15, GPS (global positioning system) 16, and other IMU (motion sensing) equipment 17 and a processor 19, as well as digital or video displays 6, and other understood I/O components understood in the art. In certain implementations, and as discussed below, the platform 10A according to certain implementations executes a process to provide an AR window 8 on the display 6.

Additionally, various implementations comprise an operating system 18 running on the processor 19, as well as storage 21 and has networking capabilities, such as wireless, cellular or Bluetooth® components (network connections being designated generally with reference number 4) for the storage and transmission of data to a server 20, such as a cloud server 20, which in certain implementations is in operational communication with a database/repository 25, such as a blockchain 22. It is understood that various additional components may be used, and that no component is critical. While several embodiments are described in detail herein, further embodiments and configurations are possible.

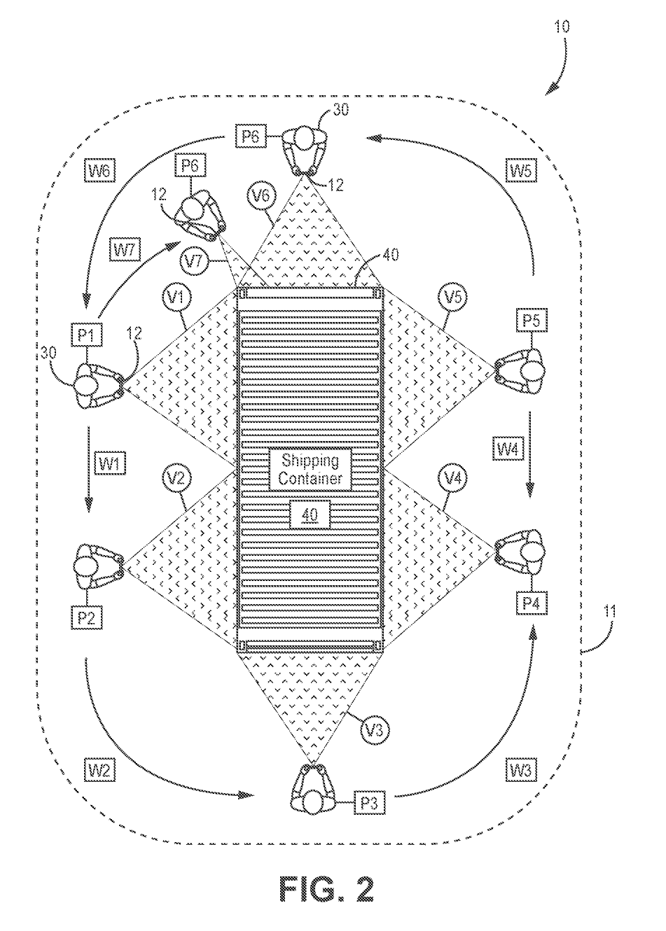

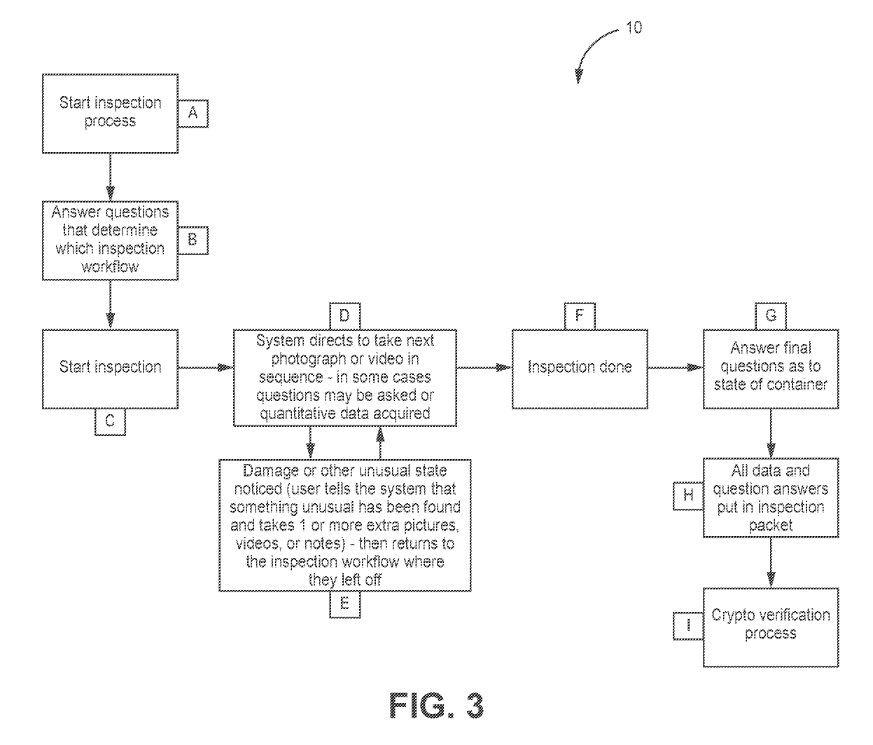

As shown in FIGS. 2-3, according to various implementations, in use the system 10 is constructed and arranged to capture data 24 to document the condition of an object 40 used in industrial transport equipment, such as a shipping container 40 via data capture and storage. Those of skill in the art will readily appreciate that alternate implementations of the system 10 may be used in the described fashion on myriad additional objects 40.

In some embodiments, the system 10 validates the authenticity and unaltered state of the inspection including photographs and videos via validation data, such as via cryptographic signatures and an internal blockchain or other database/repository based on the validation system disclosed in co-pending U.S. application Ser. No. 15/631,928 (filed on Jun. 23, 2017 and entitled “Cryptographic Signature System and Related Systems and Methods”), which is incorporated in its entirety by reference. It is understood that in these implementations, the system 10 allows for the validation of data. That is, in one illustrative example, a rental car returned with a dent can be checked against the stored images of the dented area prior to the rental. It is understood that the use of such validation data/techniques prevents the computer-savvy renter-denter from falsifying stored rental car inspection data. Alternatively, the accused renter-denter could prevent claims of damage levied by a less-reputable rental company by utilizing the system to verify the state of the car prior to rental.

In various implementations, data collected—such as photos, videos, sensor data, and user input/notes—are then converted into an inspection packet 24 that may contain any of the collected data—including, for example digital image data and/or secondary/validation data—and is stored as a file on the device (shown at 21/24 in FIG. 1). In various implementations, the storage file 24 is then transmitted 4 and stored on a server 20/in a database 25. The data may also be hashed to create a cryptographic signature 24A—validation data—thereby validating the integrity of the data in the file 24/24A. In certain implementations, a duplicate of the cryptographic signature 24B and the time stamp is stored on another database 25/repository 22, such as a blockchain 22, ledger of time stamps, or Merkle tree. The cryptographic signatures 24A and 24B may then be compared with a recreated signature from the storage file (best shown in FIG. 1 at 21/24) for use in detecting alterations and changes and providing a highly tamper resistant authenticated record of the inspection. It is understood that in many implementations, the validation data includes AR tracking data that is acquired at the time of the inspection of the data packet.

In use, as shown in FIG. 2, an exemplary embodiment of the augmented reality (AR) inspection system 10 and various computer vision capabilities of the system guide the inspector 30 to take photos or video of different angles of the various elements of the storage container 40 as the inspector 30 walks around the equipment in such a way that the inspection may be completed naturally and quickly. For example, the inspector 30 may utilize the system 10 to perform a series of optional, and optionally guided, steps. That is, it is understood that in various implementations the system 10 may provide one or more guided steps to the inspector 30, such as via a screen on the device 12.

In the exemplar implementation of FIG. 2, in a first optional step, the inspector 30 is guided to start at point P1 and to use the device and application 12 to inspect a portion V1 of the shipping container or object 40 via data capture, such as digital image capture and storage via the device 12. In another optional step, the inspector 30 is instructed to then walk via path W1 to inspection point P2 to inspect another portion V2 of the shipping container or other object 40 and capture data. In a series of subsequent optional steps, the inspector is guided to repeat this process moving to inspection points P3, P4, P5, and P6 along the path defined by W2, W3, W4, W5, and W6 until the inspection via data capture of each portion V1, V2, V3, V4, V5 and V6 is completed. As described below, in an optional additional step, the system 10 may direct the user 30 via AR 8 to walk W7 to an additional position P7 so as to capture further data about a portion V7 of interest, such as an area the system 10 has identified to have sustained damage.

It is understood that this workflow management enables the rapid inspection of the transport equipment utilizing the AR capabilities of the mobile computing device 12 and knowledge of the type of transport equipment ensures that the inspection is complete and no areas of the equipment or other object 40 are missed and that all relevant data is captured and stored.

It is understood that in certain implementations, the inspector 30 may quickly note any apparent damage to the transport equipment or other object 40, such as via manual input into the device 12. During and following each of the optional steps, the data capture results of the inspection according to these implementations are then converted into a data/information file 24 and cryptographically hashed and stored in the repository 22 as discussed above in relation to FIG. 1. It is appreciated that various implementations may be stored according to any of the described approaches discussed or otherwise incorporated herein.

The workflow of an exemplary embodiment is shown in detail in FIG. 3. In this exemplary embodiment, several steps are performed for illustrative purposes. It is understood that alternate numbers and sequences of steps may be performed.

As shown in the implementation of FIG. 3, the inspection process is initiated (box A) when the inspector (such as shown at 30 in FIG. 2) opens or otherwise starts the inspection application on the mobile computing device 12. As described in relation to FIG. 2, the inspector according to certain implementations is then directed to answer a series of questions about the specific inspection (box B) that may be used to tailor and guide the inspection workflow and the data capture records required for the task/object 40.

In an optional step according to this implementation, the inspection is initiated (box C) and the inspection and validation system 10 directs the inspection (box D). During the inspection, the system 10 may ask for additional quantitative or qualitative information, such as manual or automatic input via a device 12. In addition, as another optional step, during the inspection the inspector 30 may note to the system that damage or some other unusual state exists (box E) and record additional documentation including but not limited to extra pictures, videos, notes, or audio recordings—and then resume the inspection workflow at the point where the damage or unusual state was noted.

In a further optional step, at the completion of the inspection (box F), the application may direct the operator to answer any final questions as to the state of the container (box G). In an additional optional step, some or all of the captured data, including operator inputs, photographs, videos, notes, sensor reading, and other information, is assembled into an inspection packet (box H). In a subsequent optional step, the inspection packet is placed or otherwise formatted in a cryptographic format (box I) that supports authentication of the inspection results and performance as described in relation to FIG. 1. It is appreciated that many other processes comprising variations of some or all of these steps, or including alternate steps appreciated by those of skill in the art may be used.

In a further implementation, the system 10 is configured such that various machine learning and/or artificial intelligence (“AI”) techniques use AR and computer vision data 24 from the previously taken photos or video stored (such as in the blockchain 24B) to highlight areas of damage. These areas of damage may then be identified to the inspector, who may be alerted to obtain more detailed images and information as needed to fully document the damage to the transport equipment. In various alternate implementations, the system 10 may be constructed and arranged to perform object detection methodology, such as via convolutional neural networks (CNN), into the system to automatically detect damage. In these embodiments the 3 dimensional tracking history, feature detection and object detection performed may be included in the inspection packet 24.

In some embodiments, the system 10 uses the results of object detection, metadata and other analysis to trigger subsequent action. Some examples of possible triggers for a subsequent action include damage detection, object detection, named element extraction from text, text pattern matching, rule-based matching on metadata, collected objects, and text; and a defined geographic area. In various implementations, the results of additional automated processing of the inspection data triggers another action based on the contents of the imagery, other data collected or metadata. Some possible triggers for another action include damage detection using convolutional neural nets, optical character recognition and/or the extraction of sequences of characters or image characteristics that match either defined rules or a statistical inference of the probability that the image or associated text contains a shipping container code, drivers license number, VIN number, license plate or other alphanumeric identifier.

In an additional embodiment, the system 10 uses various machine learning/artificial intelligence (AI) techniques that use the AR and computer vision results outlined above combined with a knowledge of the type of container from the ISO identification code to certify and provide a record that the inspection job is complete. It is understood that the device 12, with the various I/O components 2 including cameras 14, inclinometers 15, GPS (global positioning system) 16, and other IMU (motion sensing) equipment 17, may be integrated together to verify the path of the inspector 30 and the images and information gathered are sufficient to document the completion of the inspection.

In some embodiments the system 10 gathers the inspection data from a single inspection into a single inspection packet. This inspection packet may be verified with a single cryptographic hash and may use any of a variety of archive formats including zip, tar, or simply appending files into one large file.

In certain embodiments where even greater cryptographic security is desired, each individual captured datum relating to a piece of inspection evidence may be hashed individually to create a Merkle tree where the cryptographic hashes of each piece of evidence represent the leaves of the tree, and the root of the tree is anchored in the database/repository, which is then eventually anchored to a publicly verifiable cryptographic hash such as the bitcoin blockchain or elsewhere. These implementations enable each individual datum to be independently verified with a proof consisting of only the portions of the Merkle tree necessary to prove the anchoring of that datum to the publicly verifiable cryptographic hash.

According to certain embodiments, the system captures qualitative and quantitative data from other smart devices connected via Bluetooth®, NFC, other communications technologies or via visual recognition, as would be understood. This data is timestamped and is recorded in the inspection packet along with the sensor, photo, and/or video data. This combination of the picture and/or video and sensor data along with the data from other smart devices ensures that the smart device data is collected from devices that are actually present on the container being inspected and provides an additional level of authentication of the inspection record.

In various implementations, the system 10 captures data from the user when the user believes there is either damage to the container and associated equipment being inspected or there is some other exceptional aspect that warrants calling attention to or flagging.

In certain embodiments, the system 10 is constructed and arranged to identify potential damage live using advanced computer vision techniques on captured data in real-time and, in a subsequent step, direct the user to get close-up or collect/capture multi-angle digital image and video data or gather other additional information about the suspected damage to the object 40. In these implementations, the system 10 is configured to perform analysis of the object 40 or objects in view of the device 12 camera using convolutional deep neural networks or other object classification methods trained to detect and classify damage to the object(s) 40 being inspected, as would be readily understood by those of skill in the art. The system 10 according to these implementations may also be constructed and arranged to guide or otherwise prompt the user to capture close-up images, including from multiple angles and/or other relevant imagery of the damaged area depending on any assessment of the type and/or severity of damage detected.

In certain embodiments, the system 10 is configured to capture damage claims data used to go review and find instances of damage to the object 40. In various implementations, the system 10 may label the digital image/visual evidence of the damage. The labeling may be performed either manually (such as being human-assisted) or automatically (such as via CNN or the like) at either an inspection, photo, region of interest, or pixel segmentation level. It is appreciated that this labeling is used to improve future automatic damage detection that occurs both live and after inspections take place.

According to certain embodiments, the inspection process may change depending on the inspection needs and the types/configurations of the equipment being inspected. For example, the workflow for the inspection of a 40 foot container might be somewhat different than that for a 20 foot container. In another example, a container which has been flagged as having been damaged either by an earlier inspection, the current inspector, or the inspection software may require a different inspection workflow.

According to certain embodiments, the data from smart devices such as smart locks or damage sensors may be used to correlate damage or tampering states with the visual evidence detected by the system in cases where said smart devices are available. This data from smart locks or damage sensors may be included in the inspection packet 24 described above.

### Example 1: Light-Weight AR

In certain implementations, a “light-weight” augmented reality (“AR”) interface is utilized with the system 10. In these implementations, the AR executes a series of optional steps such as generating and displaying instructions on the device 12 screen to direct the user through specific requirements of the object 40 inspection process. For instance, capturing specific regions or sections at different resolutions. It is understood that, for example, in the case of a shipping container or rental car, certain regions of those objects may be more likely to sustain damage, including relatively small damage. In various implementations, these AR directions remain in a fixed or user-configurable location—such as displayed a floating window—on the mobile device's 12 screen and in certain implementations, the instructions may change depending on, or be dictated by, the nature or character of already-captured inspection data, such as in cloud storage or a database.

Example 2: Heavy-Weight AR

In other embodiments a spatially-aware augmented reality interface would help direct the user to the right location in space by providing visual navigation cues on screen and letting the user know when they have captured the necessary imagery for a given step by use of a procedure.

### I. Inputs

In this example use of AR, several optional inputs are utilized, as follows.

System starting position. In certain aspects, the starting position obtained with spatial tracking from an augmented reality platform such as ARKit, ARCore or Vuforia can be used as an input. Alternate starting position inputs may be utilized in further aspects.

Object details. In various aspects, necessary elements of the inspected object to capture—such as individual components, surfaces, mechanisms and the like—primary surface orientations from which the camera orientations and positions relative to the individual components from which effective imagery can be captured can be derived, and the optional order images or data should be captured in can be inputs. It is understood that these elements may be able to be captured in a single camera view for each primary surface orientation. It is further understood that additional elements can be utilized as inputs.

Object location. In aspects, the location such as the three-dimensional location of and shape of object to be inspected is utilized as an input.

Technical details. In certain aspects, technical information relating to the system and object are utilized as inputs. For example, the pixel density and distance-to-camera requirements for inspected surfaces may be inputted into the system for use via AR.

Live inputs. In various aspects, the system is updated throughout the inspection as the user moves and utilizes the device 12. For example, in certain optional aspects, the current position of the user in relation to the inspected object is inputted and updated. In further or alternate aspects, the updated estimations of the current position of the inspected object.

While these example inputs are detailed, it is readily appreciated that additional inputs may be utilized in alternate implementations of the system, and that each of the foregoing examples is non-limiting and purely illustrative.

### II. Example Pre-Procedure Aspects

In various implementations and examples of the system 10, certain optional AR pre-procedure steps having certain aspects may be employed. Other aspects are of course possible.

In one optional step, the user prepares the system for spatial tracking in the AR platform. In this illustrative example, the user may move device around as needed, orient to marker, or the like to establish the base reference frame or other home location.

In a further optional step, the user, system and/or device may prepare for the inspection by establishing a current location of the device in relation to the inspected object. Some illustrative possibilities include:

In one pre-procedure aspect, orienting to a marker or known feature on the object, such as the door to a container, the side of a cab on a truck or the like;

In a pre-procedure aspect regarding an object with largely flat sides, such as a shipping container, the system may be used to detect the flat sides using either the surface finding ability of the AR platform used or by using feature tracking from either the AR platform or ORB, SIFT, SURF, or BRIEF. If using feature tracking use RANSAC (random sample consensus) to find flat planes. It is understood that using a combination of plane detection and object recognition find the most plausible location and orientation of the object relative to the camera. Use constraints such as the expected orientation of the object in relation to gravity to further constrain the search space for plausible orientations for shipping containers and other objects rest flat on the ground.

In further pre-procedure aspects, the system may utilize the 3D object tracking capability of the underlying augmented reality platform to find the position of the object relative to the camera. Other aspects and pre-procedure utilizations will be appreciated by those of skill in the art.

While these example pre-procedure optional steps are detailed, it is readily appreciated that additional pre-procedure optional steps may be utilized in alternate implementations of the system, and that each of the foregoing examples is non-limiting and purely illustrative.

### III. Example Procedure Aspects

In various implementations and examples of the system 10, certain optional AR procedure steps having certain aspects may be employed. Other aspects are of course possible.

In a first optional step, the procedure may begin by a direction or prompting/guidance to inspect (capture data from) either the first element—if the object 40 elements have an ordering—or with the closest item to the user if the object is un-ordered.

In another optional step, the system may direct the user to move the camera in such a way that adequate imagery of the current inspection element is data captured, thereby recording still images and video when relevant. In certain optional steps or serialized, sub-steps, this movement may use an algorithm like that provided below.

In another optional step, after the directed appropriate imagery is captured for each inspection element/object, the system directs the user to move on to either the next element in the list or the next closest element.

While these example procedure optional steps are detailed, it is readily appreciated that additional procedure optional steps may be utilized in alternate implementations of the system, and that each of the foregoing examples is non-limiting and purely illustrative.

### IV. Algorithm for Directing the Inspection of an Element

Using one or more of: knowledge of the live location of the mobile camera, the optical characteristics, the requirements for image capture, and the location and primary surface orientations of the inspected element, it is possible for the system 10 to determine and show on the screen the direction that the user should move and turn the camera to get a preferable view of the inspected element.

For example: “move left”, “move right”, “move back”, “move forward”, “turn right”, “turn left” , “point camera down”, “point camera up”, and the like, or visual representations of the same. For movements parallel to the ground a directional arrow and distance can be used. For up/down movements a up/down arrow or textual message as well as distance can be used.
Steps:
FOR EACH inspection surface orientation
1. Determine acceptable bounds of camera position and orientation relative to the inspection element and the surface orientation that is currently active
2. IF the position is outside the acceptable bounds in the directions parallel to the ground (left right, back, forward) direct the user to move the mobile device in the direction relative to the screen orientation using textual display or a direction arrow using an overhead map.
ELSE IF the position is outside the acceptable bounds in the direction perpendicular to the ground (up/down) tell the user to move the mobile device up or down and how far.
ELSE IF the pitch is outside acceptable bounds tell the user to rotate the mobile device up or down appropriately
ELSE IF the yaw is outside acceptable bounds tell the user to rotate the mobile device right or left appropriately
3. If position and orientation are within acceptable parameters take a photograph and add it to the inspection package with the inspected element and surface orientation tagged and proceed
ELSE return to step

Although the disclosure has been described with reference to certain embodiments, persons skilled in the art will recognize that changes may be made in form and detail without departing from the spirit and scope of the disclosed apparatus, systems and methods. Such that the various embodiments and steps described can be performed in a variety of orders and combinations without departing from the scope of the disclosure.

What is claimed is:

1. A system for documenting the condition of containers, comprising:
(a) a networked device comprising a processor and at least one I/O component; and
(b) a networked repository, wherein the networked device is constructed and arranged to:
(i) capture inspection data into an inspection data packet,
(ii) compute a cryptographic hash of the inspection data packet, and
(iii) transmit the cryptographic hash to the networked repository for storage.

2. The system of claim 1, wherein the system is configured to integrate visual tracking into the system for guidance.

3. The system of claim 2, wherein visual tracking data is integrated into the inspection data packet.

4. The system of claim 1, wherein the system is configured to integrate augmented reality (AR) into the system for guidance.

5. The system of claim 4, wherein the networked device is constructed and arranged to integrate feature, object detection, plane detection and tracking data from the AR into the inspection data packet.

6. The system of claim 4, wherein the system is constructed and arranged to validate packets via at least one of the feature, object detection, plane detection and tracking data.

7. The system of claim 1, wherein the system is configured to integrate data from a combination of fixed and mobile cameras into the system.

8. The system of claim 1, wherein the system is configured to perform object detection methodology to automatically detect damage.

9. The system of claim 8, wherein the object detection is performed via convolutional neural networks (CNN).

10. An inspection system, comprising:
(a) an inspection device comprising a processor and at least one camera;
(b) a repository comprising a blockchain, wherein the inspection device is constructed and arranged to:
(i) execute one or more inspection and / or guidance steps,
(ii) capture inspection data, and
(iii) transmit captured inspection data to the repository.

11. The system of claim 10, wherein the processor is constructed and arranged such that additional automated processing of the inspection data triggers another action based on at least one of detected objects or detected object states of the imagery, other data collected or metadata.

12. The system of claim 11, wherein the trigger includes damage detection using convolutional neural nets, optical character recognition and/or the extraction of sequences of characters or image characteristics that match either defined rules or a statistical inference of the probability that the image or associated text contains a shipping container code, drivers license number, VIN number, license plate or other alphanumeric identifier.

13. The system of claim 11, wherein the processor uses a defined area as the trigger.

14. An inspection and storage system, comprising:
(a) a networked device comprising a processor, a camera and an augmented reality interface; and
(b) a repository,
wherein the networked device is executing an inspection platform constructed and arranged to:
(i) execute a series of guidance steps,
(ii) capture a series of data relating to an inspected object,
(iii) hash and store the captured data via an inspected packet in the repository, and
(iv) validate queries to the hashed and stored data.

15. The system of claim 14, wherein the system is constructed and arranged to generate a cryptographic signature.

16. The system of claim 15, wherein the system is constructed and arranged to validate captured data via the stored cryptographic signature.

17. The system of claim 15, wherein duplicate cryptographic signatures are stored on the device and in the repository.

18. The system of claim 14, wherein the guidance steps optionally include directed inspection of at least one portion of the object.

19. The system of claim 14, wherein the processor is constructed and arranged to utilize computer vision.

20. The system of claim 19, wherein the computer vision is configured to identify portions of damage to the object and the guidance steps are revised in response to identified damage.
